(19) United States
(12) Patent Application Publication
(10) Pub. No.: US 2006/0201048 A1
(43) Pub. Date: Sep. 14, 2006

(54) Autojug

(76) Inventors: James Garriott, Wagoner, OK (US); Mark Garriott, Wagoner, OK (US)

Correspondence Address: Wilson Daniel Swayze, Jr, 3804 Clearwater Ct, Plano, TX, 75025, US

(21) Appl. No.: 11/074,974

(22) Filed: Mar. 8, 2005

(51) Int. Cl. A01K 93/02

(52) U.S. Cl. 43/17; 43/42.31; 43/44.87

(57) ABSTRACT

Described herein is a fishing device that uses a sliding weight to force a float assembly to a unique position and hold it in that position until it is reset. This indicates to fishermen that a strike has occurred. The actual device consists of a tube sealed on each end containing a loose weight. This assembly is installed in a rectangular plastic foam float, a hollow molded plastic float, or any suitable float. The tube assembly is installed through the center of the longest dimension of the float. The tube has an end ‘A’ and an end ‘B’. End ‘A’ has an eyelet installed for attaching a fishing line. The line is a sufficient length to allow an anchor, which is attached to the end of the line, to reach the bottom. This line also contains fishing hook(s). The weight of the anchor is calculated to counter the force exerted by the fish thus allowing it (the force) to be transferred to end ‘A’ of the tube. This causes the float assembly to tilt, and when the tube reaches an angle of about 30°, the internal sliding weight free falls to end ‘A’ causing the float assembly to snap up to a vertical position. The assembly stays in the vertical position until reset by the fishermen. The audible sound created by the weight striking end ‘A’ is a useful feature that tells the fishermen to check for a standing float. This would occur in night fishing. When resetting the float device after it has been triggered, and the fish remove, end ‘A’ is grasped by the fishermen handheld vertical to allow the internal sliding weight to drop back to end ‘B’. The float is then lowered to the surface of the water where it assumes a slightly off-horizontal position. The center of gravity of the float device (in the ‘set’ position) is adjustable by sliding the tube assembly in or out of the float; this allows the device to assume the proper horizontal position. The device does not contain paint or any other known contaminants. Its natural color is white and is visible for long distances when in the up-right position.

### FIELD OF THE INVENTION

This invention relates to a bated hook and line fishing including a technique known as jug fishing.

### BACKGROUND OF THE INVENTION

Jug fishing is an effective way of catching fish, especially catfish. This fishing technique consists of tying a line with a baited hook and sinker weight onto an empty plastic jug, typically a large jug. The apparatus floats on the surface of the water above where fish are likely to be feeding. When a fish is hooked the jug will bob up and down for a few moments, which indicate fish movement.

Many states allow the fisherman to use a number of jugs. As the number of jugs increase, it becomes increasingly difficult to keep track of all the jugs and to determine which ones have caught a fish. It would be desirable to have a positive indication that a fish has been caught, and it would be desirable that this positive indication that a fish has been caught be independent of the movement or lack of movement of the fish

### SUMMARY OF THE INVENTION

The present invention provides a positive indication that a fish has been caught, and this indication does not change regardless of the motion or lack of motion of the hooked fish. A main body includes a plastic foam float that is positioned along the, substantially horizontal axis of the water surface. From this position, when a fish pulls on an attached baited hook and line the main body rotates vertically to approximately 90 degrees. This provides an indication that a fish has been caught. Additionally, the center of gravity of the float system is changed so that it cannot return to the horizontal position.

### BRIEF DESCRIPTION OF DRAWINGS

FIG. 1 illustrates a top view of the Autojug Fisher

FIG. 2 Illustrates a side cut-away view of the Autojug Fisher and trigger mechanism.

FIG. 3 illustrates another side cut-away view of the main Autojug Fisher body and trigger mechanism.

FIG. 4 illustrates a side view cut-away of the Autojug Fisher body after a fish has been caught.

### DETAILED DESCRIPTION OF THE AUTOJUG FISHER

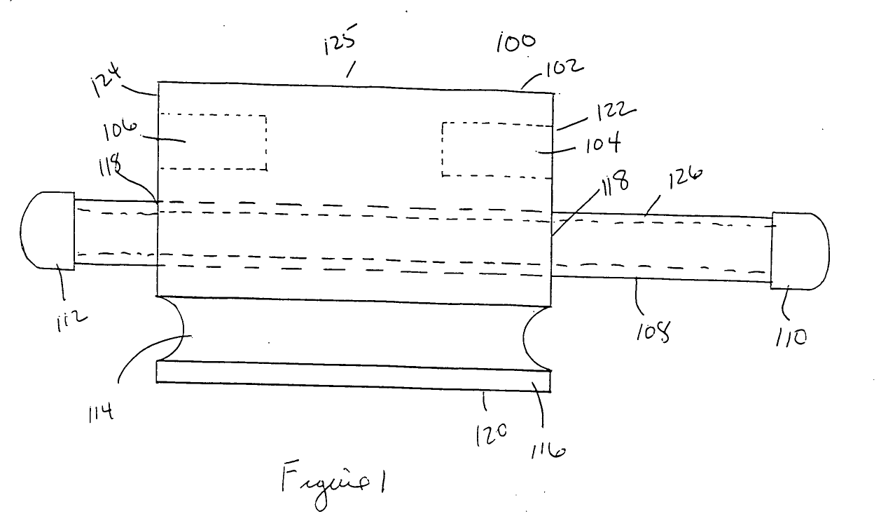

FIG. 1 shows an Autojug Fisher 100 including a rectangular body 102, which is shown setting on its side. The main body 102 could be other shapes such as cylindrical. The main body 102 includes end surfaces 122, 124; each or alternatively one of the end surfaces 122,124 includes recessed generally cylindrical holes 104, 106 to receive an anchor weight. Preferably, the holes 104, 106 are dimensioned so that the weight is frictionally retained within the main body 102 for storage. Part of the main body 102 is a groove 114 extending completely around the main body 102 to allow fishing line to be wrapped and retained around the groove 114. At the groove side of the main body 102 is a narrow flat surface 116 at this side is flat side surface 120, and a second flat side surface 125 is positioned at the opposite side of main body 102 and generally parallel to flat side surface 120. A cylindrical hole 118 extends through main body 102 to allow pipe 108 to pass through the main body 102. Pipe 108 includes wall 126 and pipe caps 110 and 112 the caps have a cylinder side wall and a domed lid and an open end and are slightly larger in diameter than pipe 108 so that the pipe caps 110, 112 form a water tight seal with 108. Pipe 108 can be moved in the main body 102 so that the static center of gravity can be established for the Autojug Fisher. The ability to change the center of gravity allows the Autojug Fisher to be adjusted for rough water conditions, and set the balance of the device for fishing.

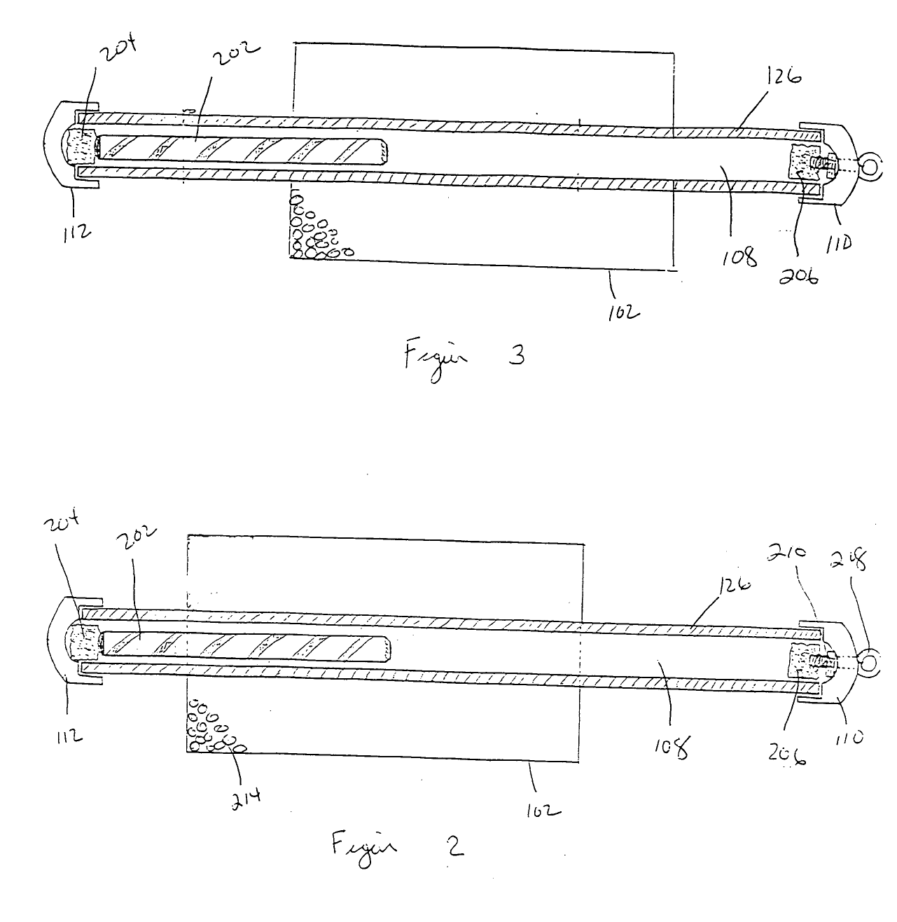

FIG. 2 illustrates additional features of the Autojug Fisher. More particularly, FIG. 2 shows a sliding weight 202 which travels along the inside of pipe 108 which acts as an automatic trigger mechanism that forces the main body 102 to stand on end until reset. This acts as a memory device remembering and signaling to the fisherman that a strike has occurred. When the weight 202 travels or moves along cylinder 108, the center of gravity of the Autojug Fisher changes such that the Autojug Fisher rotates 90 degrees. This change in orientation from a substantially horizontal orientation to the substantially vertical orientation provides the desired indication to the fisherman that a fish has been hooked, or a strike has occurred.

Continuing with FIG. 2, FIG. 2 illustrates that small foam bumpers 204, 206 are positioned at each end of pipe 108 to damp the force of the sliding weight 202. When the free sliding weight 202 strikes the shaft of the fishing line attachment eye 208, an audible sound will be emitted providing an audible indication that a fish has been caught. This is helpful in night fishing. A line attachment eye 208 protrudes from the pipe cap 110, and a shaft extends through the pipe cap 110 and is threaded for a nut.

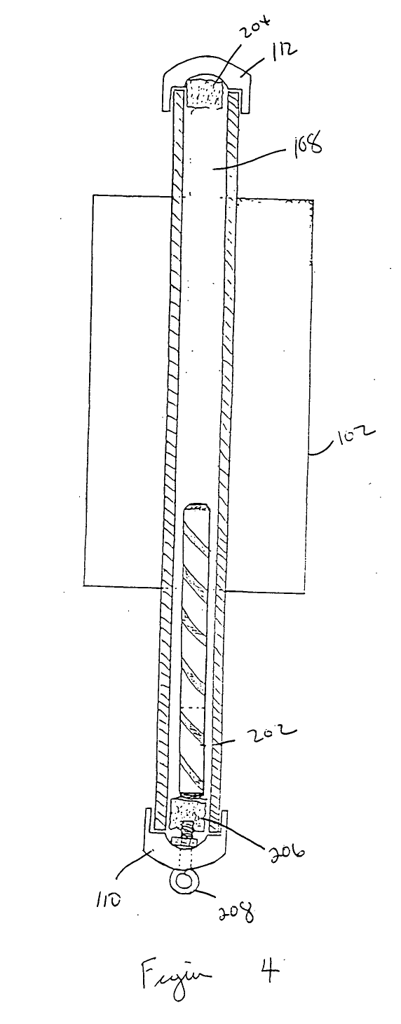

Comparing FIG. 2 and 3, FIG. 3 shows that the main body 102 has been moved along the pipe 108 closer to pipe cap 110. This is the static center of gravity adjustment.

In operation the anchor weight is taken from the anchor weight compartment 104 and fishing line is unwound from the line storage grove 114. It is attached to line attachment eye 208. The other end of the line is fitted with proper size hooks and the anchor weight is attached. The hooks are baited and the line assembly is lowered into the water. When the anchor reaches the desired depth the fishing line is tied-off to the main body 102. The main body 102 is placed in the water with the weight 202 shifted in the pipe 108 to cap end 112. The main body assembly will assume an almost horizontal orientation depending on the static center of gravity adjustment. When a fish strikes the baited hook force exerted by the fish pulls down on the assembly. When the assembly body 102 and trigger tube pipe 108 are tilted to about 30 degrees the assembly pops up to vertical as the weight slides to the end where the force is applied. The center of gravity of the apparatus has been shifted and will remain so until reset by hand. A sound audible to a human was emitted when the weight 202 struck the eye screw 210.

The embodiment described and shown to illustrate the present invention has been necessarily specific for purposes of illustration. Alterations, extensions and modifications would be apparent to those skilled in the art. The aim of the appended claims, is to cover all variations included within the spirit and scope of the invention.

1) A fishing apparatus, comprising:
a main body,
two side surfaces at opposite ends of said main body,
a movable apparatus to move between said two side surfaces to change the center of gravity of said fishing apparatus.

2) A fishing apparatus as in claim 1, wherein said movable apparatus is a sliding weight assembly.

3) A fishing apparatus as in claim 1, wherein said main body is made from plastic.

4) A fishing apparatus as in claim 1, wherein said main body includes a hole for a weight.

5) A fishing apparatus as in claim 2, wherein said movable apparatus further includes a free falling weight.

6) A fishing apparatus as in claim 5, wherein said free falling weight is movable within said cylinder.

7) A fishing apparatus as in claim 2, wherein said cylinder includes an eyelet for attaching a fishing line.

8) A fishing apparatus as in claim 2, wherein said main body includes a groove to stowing fishing line.

9) A fishing apparatus as in claim 2, wherein said cylinder includes a free falling weight to cause an audible noise when the center of gravity is changed.

10) A method of producing a fishing apparatus, comprising the steps of:
forming a floatable main body,
forming two side surfaces at opposite ends of said main body,
forming a movable apparatus to move between said two side surfaces to change the center of gravity of said fishing apparatus.

11) A method of producing a fishing apparatus as in claim 10, wherein said step of forming said movable apparatus includes the step of forming a hollow cylinder.

12) A method of producing a fishing apparatus as in claim 10, wherein the step of forming said movable apparatus includes the step of forming of a free falling weight.

13) A method of producing a fishing apparatus as in claim 10, wherein said fishing apparatus is a jug fishing apparatus.

14) A fishing apparatus as in claim 11, wherein the step of forming said movable apparatus further includes the step of forming a free falling weight.

15) A fishing apparatus as in claim 14, wherein said free falling weight is movable within said cylinder.

16) A fishing apparatus as in claim 11, wherein the step of forming said cylinder includes the step of forming an eyelet for attaching a fishing line.

17) A fishing apparatus as in claim 11, wherein the step of forming said cylinder includes the step of forming a cap.

18) A fishing apparatus as in claim 11, wherein the step of forming said cylinder includes the step of forming a shaft to cause an audible noise when the center of gravity is changed.
